(19) United States
(12) Patent Application Publication
(10) Pub. No.: US 2007/0221899 A1
(43) Pub. Date: Sep. 27, 2007

(54) GRAPPLE ANCHOR

(76) Inventor: TOM BRAITHWAITE, Ancaster (CA)

Correspondence Address: MARK A KOCH, 866 MAIN STREET EAST, HAMILTON, ON, L8M1L9, US

(21) Appl. No.: 11/688,343

(22) Filed: Mar. 20, 2007

Related U.S. Application Data
(60) Provisional application No. 60/767,415, filed on Mar. 27, 2006.

(51) Int. Cl. B60S 9/02

(52) U.S. Cl. 254/418

(57) ABSTRACT

A grapple anchor for attachment to a vehicle receiver hitch, the grapple anchor comprising a draw bar having one end adapted to be received into a receiver hitch, the other end rigidly attached to a cross bar which extends perpendicular to the draw bar, the cross bar further including screw jacks rigidly attached to each distal end of the cross bar, the cross bar further including rope eyelets adapted and dimensioned to receive grappling rope there through.

The application claims priority from previously filed U.S. provisional patent application No. 60/60/767,415, titled “GRAPPLE ANCHOR” on Mar. 27, 2006 by Tom Braithwaite.

### FIELD OF THE INVENTION

The present invention relates to anchoring devices grappling, in particular relates to a grapple anchor which can be attached to a trailer hitch of a vehicle.

### BACKGROUND OF THE INVENTION

Currently rescue teams, fire departments and other specialty organizations that are involved with grappling for rescue safety and/or for sport purposes, will often use a vehicle for anchoring grapple ropes thereto. Currently for example, normally in a four door vehicle both the passenger and the front door are opened to expose the c-pillar running down between the two doors. Typically grappling ropes are tided off around the c-pillar of a vehicle and this tie off point is used as an anchor for attachment of grappling ropes. Government authorities have considered that this means of anchoring grappling lines is not safe and/or efficient and in many instances is not available, particularly if one is driving a two door vehicle, rather than a four door vehicle. There is a need for a more reliable, safer grappling anchor system which can be quickly and efficiently attached to vehicles which will provide the necessary strength and stability for the attachment of grappling ropes.

### SUMMARY OF THE INVENTION

A grapple anchor for attachment to a vehicle receiver hitch, the grapple anchor comprising a draw bar having one end adapted to be received into a receiver hitch, the other end rigidly attached to a cross bar which extends perpendicular to the draw bar, the cross bar further including screw jacks rigidly attached to each distal end of the cross bar, the cross bar further including rope eyelets adapted and dimensioned to receive grappling rope there through.

### BRIEF DESCRIPTION OF THE DRAWINGS

The present invention will now be described by way of example only with reference to the following drawings in which;

FIG. 1 is a top plan view of the present invention, a grapple anchor attached to a receiver hitch and also showing the bumper of a vehicle.

FIG. 2 is a front schematic elevational view of the present invention, a grapple anchor deployed on a trailer hitch together with a bumper of a vehicle.

FIG. 3 is a rear top perspective view of the present invention a grapple anchor showing detached from a receiver hitch which would be mounted onto the under carriage of a vehicle.

FIG. 4 is a front top perspective schematic view of the present invention a grapple anchor together with a receiver hitch.

### DETAILED DESCRIPTION OF THE PREFERRED EMBODIMENT

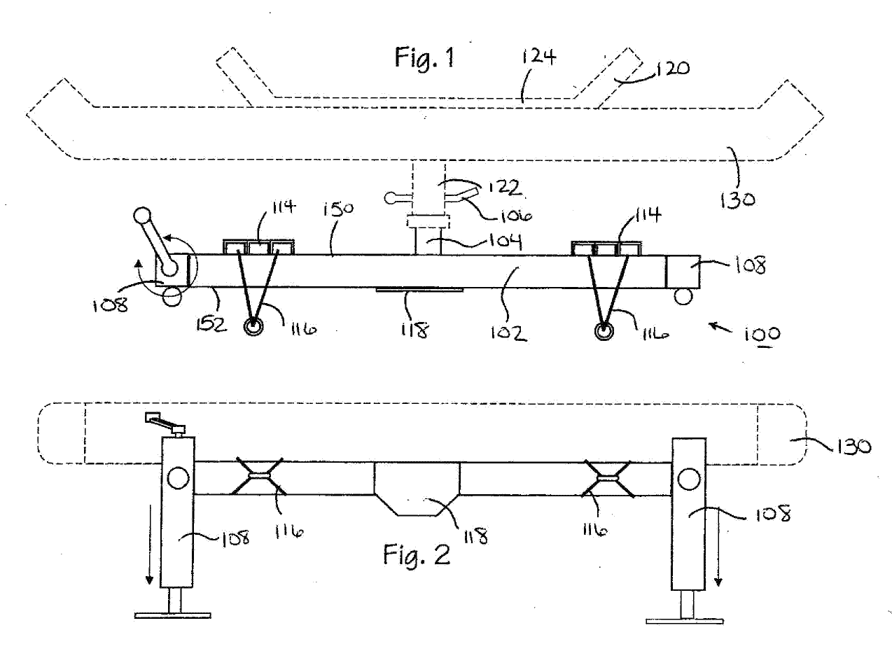

The present invention is shown generally as grapple anchor 100. In FIGS. 1 for example, grapple anchor 100 is shown deployed together with a receiver hitch 120 which is shown to demonstrate how grapple anchor 100 would be deployed in practice. Receiver hitch 120 would be any commercially available hitch, for example which would have a draw bar receiver 122 for receiving draw bar 104 of grapple anchor 100. The current invention grapple anchor 100 is adapted to be received in most commercially available receiver hitches 120 and is shown deployed and attached to a draw bar receiver 122 of a receiver hitch 120. The drawings depict a class 3 hitch; however it is possible to adapt grapple anchor to be attached to other hitch configurations and classes.

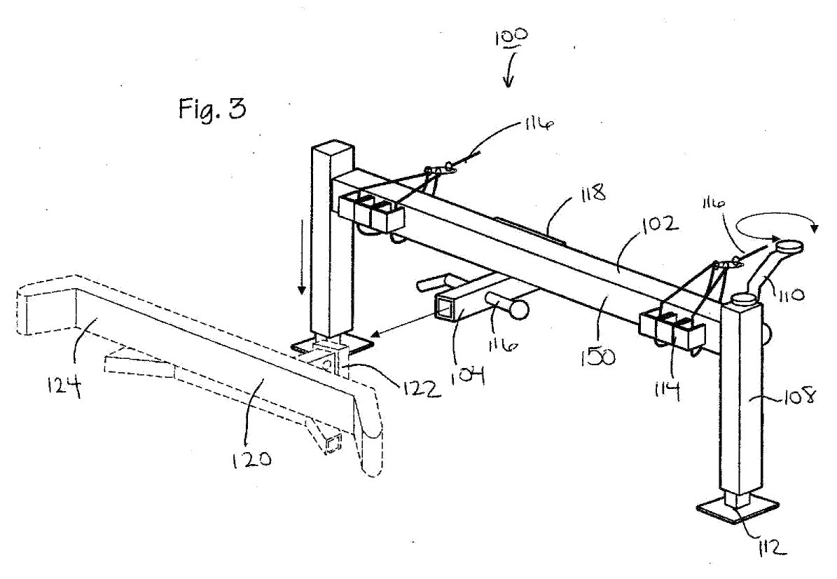

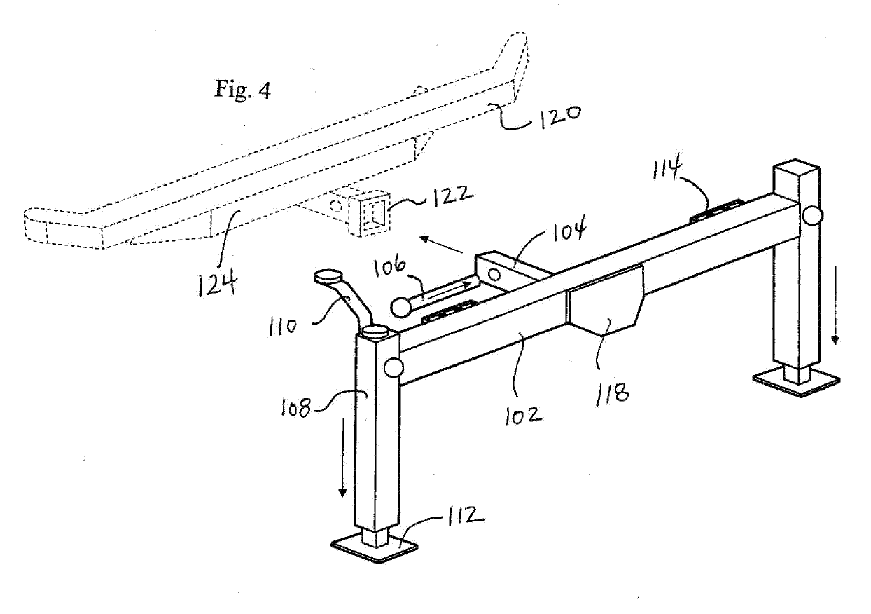

Referring now to FIG. 3 which shows the present invention, grapple anchor 100 detached from receiver hitch 120.

The major components of the present invention namely, grapple anchor 100 include cross bar 102, rigidly attached to a perpendicular oriented draw bar 104 having an aperture for receiving hitch pin 106 there through, together with screw jacks 108 mounted on each distal end of cross bar 102. Each screw jack 108 includes jack handle 110 for deploying the screw jack 108 in order to raise and/or lift jack foot 112 from the ground.

Cross bar 102 further includes a reinforcing plate 118 which reinforces the connection between draw bar 104 and cross bar 102. Cross bar 102 further includes rope eyelets 114 rigidly attached to the rear face 150 of cross bar 102. In practice, rope eyelets 114 are simply made from u-channels which are connected together and welded to the rear face of rear face 150 of cross bar 102. Grapple anchor 100 includes the above mentioned following major components and in use attached thereto is grappling rope 116 which is fed through one or more rope eyelets 11 4 in order to provide an attachment point for grappling rope 116. As can be seen from the drawings in the example shown in FIG. 3 and FIG. 1 for example, two ropes are fed through two independent rope eyelets 114 in order to produce a harness for attachment of grappling rope 116

Receiver hitch 120 may be any commercially available hitch. The novel aspects of the current invention do not include aspects of receiver hitch 120. The current invention simply attaches via draw bar 104 to draw bar receiver 122 of receiver hitch 120. Receiver hitch 120 normally includes receiver frame 124 which is securely connected to the under carriage of a automobile, truck and/or other vehicle.

### In Use

In a situation where an emergency rescue crew needs to carry out some grappling by securing themselves to a grappling rope 116, grapple anchor 100 would be attached to a receiver hitch 120 by slideably inserting draw bar 104 into draw bar receiver 122 of receiver hitch 120. Thereafter, hitch pin 106 would be inserted through the appropriate pin apertures which are defined in both draw bar 104 and draw bar receiver 122. In this manner, grapple anchor 100 is securely connected to receiver hitch 120 which in turn is securely connected to the under carriage of a vehicle. This now provides for a secure connection to any particular vehicle having a receiver hitch 120.

To further increase the stability of grapple anchor 100, screw jacks 108 located on each distal end of cross bar 102 are lowered by turning jack handles 110, until jack foots 112 impinge upon the ground there beneath,

A rope harness is normally connected around cross bar 102 by feeding one or more ropes through rope eyelets 114 which are then connected further to a grappling rope 116. The number and connection of the ropes is not the subject matter of this invention, other than to say each jurisdiction has its convention in regards to how ropes are tied off to grapple anchor 100. Grapple anchor 100 provides a number of rope eyelets 11 4 for a strong tie off along cross bar 102 in order to allow one to securely and safely attach grappling rope 116 thereto.

It should be apparent to persons skilled in the arts that various modifications and adaptation of this structure described above are possible without departure from the spirit of the invention the scope of which defined in the appended claim.

What is claimed is:

1. A grapple anchor for attachment to a vehicle drawbar receiver, the grapple anchor comprising:
a) a draw bar having one end adapted to be received and releasably locked into a drawbar receiver, the other end rigidly attached to a cross bar which extends perpendicular to the draw bar,
b) the cross bar further including rope eyelets rigidly attached to the cross bar, each rope eyelet adapted and dimensioned to receive grappling rope there through.

2. The grapple anchor for attachment to a vehicle drawbar receiver claimed in claim 1 wherein the cross bar being perpendicular to the draw bar and extending horizontally and substantially parallel to the ground.

3. The grapple anchor for attachment to a vehicle drawbar receiver claimed in claim 2 wherein the cross bar further including a means for leveling and supporting the cross bar.

4. The grapple anchor for attachment to a vehicle drawbar receiver claimed in claim 3 wherein the leveling means further including lifting jacks mounted to each distal end of the cross bar.

5. The grapple anchor for attachment to a vehicle drawbar receiver claimed in claim 4 wherein the leveling means further including screw jacks mounted to each distal end of the cross bar.

6. The grapple anchor for attachment to a vehicle drawbar receiver claimed in claim 5 wherein screw jacks including a manual jack handle for raising and lowering the cross bar by manually turning the jack handle.

7. The grapple anchor for attachment to a vehicle drawbar receiver claimed in claim 5 wherein screw jacks mounted vertically to each distal end of the cross bar such that each screwjack being perpendicular to the cross bar.

8. The grapple anchor for attachment to a vehicle drawbar receiver claimed in claim 2 wherein rope eyelets are mounted to a rear face of the cross bar.

9. The grapple anchor for attachment to a vehicle drawbar receiver claimed in claim 8 wherein the rope eyelets are positioned symmetrically on each side of the cross bar relative to the centrally located drawbar.

10. A grapple anchor for attachment to a vehicle drawbar receiver, the grapple anchor comprising:
a) a draw bar having one end adapted to be received into a drawbar receiver, the other end rigidly attached to a cross bar which extends perpendicular to the draw bar,
b) the cross bar further including screw jacks rigidly attached to each distal end of the cross bar, the cross bar being perpendicular to the draw bar and extending horizontally and substantially parallel to the ground.
c) the cross bar further including rope eyelets adapted and dimensioned to receive grappling rope there through.

11. In combination a grapple anchor and a receiver hitch mounted on a vehicle comprising:
a) a draw bar receiver rigidly attached to a receiver frame;
b) a draw bar having one end adapted to be received into the receiver hitch, the other end rigidly attached to a cross bar which extends perpendicular to the draw bar,
c) the cross bar further including rope eyelets adapted and dimensioned to receive grappling rope there through.

12. The combination claimed in claim 11 wherein the cross bar being perpendicular to the draw bar and extending horizontally and substantially parallel to the ground.

13. The combination claimed in claim 12 wherein the cross bar further including screw jacks rigidly attached to each distal end of the cross bar.
